(19) United States
(12) Patent Application Publication
(10) Pub. No.: US 2002/0153043 A1
(43) Pub. Date: Oct. 24, 2002

(54) Pool Chlorinator

(76) Inventor: William C. Hillyard, Moreno Valley, CA (US)

Correspondence Address: TECHNOPROP COLTON, L.L.C., P O BOX 567685, ATLANTA, GA, 311567685

(21) Appl. No.: 09/839,435

(22) Filed: Apr. 20, 2001

(51) Int. Cl. B01F 1/00

(52) U.S. Cl. 137/268

(57) ABSTRACT

A chlorination device attaching directly to a water recirculation system that redirects a portion of the water flow stream in the water recirculating system through one or more flow indicators and control valves, into a chemical holding compartment, and then back into the water flow stream through a check valve. The chlorinator includes a chemical compartment located above and in direct fluid communication with a section of pipe, which in turn is attached directly to the water recirculation system of the pool, spa, hot tub, or other water bath. On the upstream end of the pipe, on the inside diameter, at least one intake scoop extends centrally from the pipe wall a certain distance toward the center of the pipe and redirects water flowing through the recirculation system into at least one side path that leads ultimately to the chemical compartment.

### BACKGROUND OF THE INVENTION

1. Technical Field

The invention relates generally to the technical field of devices for chlorinating pool water, such as for swimming pools, hot tubs, spas and the like, and specifically to the technical field of in line chlorinators forming a component of a water recirculation and treatment system for swimming pools, hot tubs, spas and the like.

2. Prior Art

Pool water chlorinators are necessary to ensure that the pool water contains a proper amount of chlorine so as to provide a healthy environment. A proper amount of chlorine helps prevent the growth of, for example, algae and bacteria in the pool and the pool recirculation system. For the purposes of this specification, the term pool is meant to include swimming pools, hot tubs, spas, Jacuzzis, and any other water bath requiring a chlorinating system.

Of the many chlorinating devices available, a representative sampling shows that most are difficult or awkward to operate, create a back-pressure along the water recirculation line and/or do not provide a consistent flow of chlorine into the system. U.S. Pat. No. 3,846,078 to Brett discloses a dispensing container apparatus adapted to be immersed in the liquid to be treated. The Brett '078 is a simple device allowing the user to adjust the amount of contact between the water and the chlorine. For example, once the chlorine tablets are loaded into the Brett '078 device, the device can be grossly adjusted so that a small amount of the device, and thus a small amount of a chlorinating agent, contacts the water, or so that a large amount of the device, and thus a large amount of a chlorinating agent, contacts the water, or anywhere in between. The Brett '078 device is a static device and likely would not function well in a dynamic water line, provides no means for fine adjustments, and does not allow for the adjustment of the water flow through the device.

U.S. Pat. No. 4,210,624 to Price discloses a device for chlorinating water comprising a cylindrical chamber for holding the chlorinating tablets, and a water inlet and a water outlet for allowing water to enter and exit, respectively, the chamber. Both the water inlet and the water outlet are located at the bottom of the chamber, the water inlet being valved to restrict access to the chamber and the water outlet having a check valve to prevent back flow into the chamber. The Price '624 device also provides no means for fine adjustments, and also does not allow for the adjustment of the water flow through the device.

U.S. Pat. No. 4,584,106 to Held discloses a chlorination system for distributing chlorine in a hot tub or spa. The Held '106 system comprises a tubular bypass containing a stack of chlorinating tablets. Water being pumped through the recirculation system travels through the bypass and contacts the bottom of the stack of chlorinating tablets. The chlorinated water then returns to the recirculation system and to the hot tub or spa. The Held '106 device is a static device that provides no means for fine adjustments and does not allow for the adjustment of the water flow through the device.

U.S. Pat. No. 4,896,902 to Serna discloses a chlorination system allowing for the continuous chlorination of water along with a feedback system for measuring the chlorine content of the water and adjusting the flow of the water through the system based on the measured chlorine value. The Serna '902 device is a complex and automated device reliant on an electronic system for maintaining proper chlorine levels.

U.S. Pat. No. Re33861 to Zetena discloses a pool chemical dispenser comprising a number of separate chambers, including a bellows chamber, for controlling the amount of water supplied to the device. The Zetena '861 device also utilizes periodic partial immersion of the chlorinating tablets in the water to dissolve the chlorine. Pool chemicals are placed in a first chamber and a control plate is manually adjusted to control the depth of immersion of the pool chemicals in the water. When the water level in the first chamber reaches a predetermined height, it drains into a second chamber. Once the chlorinated water in the second chamber reaches a predetermined level, it is allowed to discharge into the recirculation system. The Zetena '861 device also is a complex and automated device. U.S. Pat. No. 5,133,381 to Wood discloses a dual range periodic pool chemical dispenser similar to the Zetena '861 device.

U.S. Pat. No. 5,419,355 to Brennan discloses a device for dissolving a chlorinating tablet within a vertical tube. The Brennan '355 device cyclically allows water to enter and exit the chlorine tablet-containing cylinder, thus contacting the chlorinating tablets. When the water reaches a certain height within the cylinder, it exits through a siphon device or a discharge tube. The Brennan '355 device likely would not function well in a dynamic water line, provides no means for fine adjustments, and does not allow for the adjustment of the water flow through the device.

Thus, it can be seen that there exists a need for a chlorinating device that is functional on a dynamic water line, allows gross and fine control of water through the chlorinating tablets to ensure an appropriate and consistent amount of chlorine is being added to the water, and is simple to use. The present invention is directed to this need.

### SUMMARY OF THE INVENTION

The present invention provides a chlorination device that specifically overcomes the shortcomings of the prior art, Generally, the chlorinator of the present invention is simpler to use and is more accurate in regulating the flow of the water through the chlorinator, and thus the amount of chlorine introduced to the water. More specifically, the chlorinator is an in-line device, attaching directly to the water recirculation system, that redirects a portion of the recirculating water from the water flow stream through one or more flow indicators and control valves, into a chemical holding compartment, and then back into the water flow stream through a check valve.

The chlorinator comprises a chemical compartment located above and in direct fluid communication with a section of pipe. The section of pipe is attached directly to the water recirculation system of the pool, spa, hot tub, or other water bath. On the upstream end of the pipe, on the inside diameter, at least one intake scoop extends centrally from the pipe wall a certain distance toward the center of the pipe. This scoop redirects water flowing through the recirculation system into at least one side path that leads ultimately to the chemical compartment. A diverter/backflow valve assists both in directing water to the side paths and in preventing backflow of water and any gases, such as chlorine-containing gases, upstream to the recirculating equipment, helping to prevent corrosion of the upstream equipment.

The side path extends generally upwards from the pipe to a location proximal to the top of the chemical compartment. A control valve and flow indicator are located within the side path between the pipe and the chemical compartment. Water is redirected from the water circulation system by the scoop into the side path. The flow indicator preferably is a common floating ball indicator situated horizontally within the side path. Water flowing through the side path causes the ball to float, and the height at which the ball floats indicates the quantity of water flowing through the side path. The side path also may comprise a bypass to allow a greater quantity of water to flow through the side path. The bypass preferably allows water to flow only around the flow indicator, and not around the control valve. The bypass diverges from the water path to the flow indicator upstream from the flow indicator but within the side path downstream from the intake scoop. The bypass then converges with the water path from the flow indicator downstream from the flow indicator but within the side path upstream from the control valve and chemical compartment.

The control valve, which is user actuated by a knob on the outside of the chlorinator, allows the user to control the quantity of water flowing through the side path. The control valve preferably is located above the flow indicator, and downstream of the convergence point of the exit from the flow indicator and the exit point of the bypass. Thus, the control valve controls the entire flow from the side path, including the flow through the flow indicator and the flow through the bypass, into the chemical compartment, and can be used to increase, decrease, or stop the flow through the side path into the chemical compartment.

The chemical compartment is a generally funnel-shaped compartment dimensioned to hold an appropriate quantity of chemical. The chemical compartment specifically is designed to hold a quantity of common pool chlorination tablets, but generally can hold a quantity of other types of chemical. Water exiting the control valve is directed through a port into the chemical compartment, preferably at approximately the mid-height point of the chemical compartment. As the water gravity falls through the chemical compartment, the water contacts any chemicals within the chemical compartment, thus dissoluting the chemical into the water resulting in chemically treated water. At least a portion of the bottom wall of the chemical compartment is the upper wall of the pipe.

A return port and check valve is located through the pipe wall between the chemical compartment and the interior of the pipe, allowing the chemically treated water to exit the chemical compartment and return to the water recirculation system. The return port is located downstream from the intake scoop so that the chemically treated water is not redirected from the water circulation stream into the side paths. The check valve prevents water and gases, such as chlorine-containing gases sometimes generated in such recirculation systems, from entering the chemical compartment through the return port. The chemically treated water then mixes with the main flow of water in the recirculation system and returns to the pool, spa, hot tub, or other water bath.

It is an object of the present invention to provide a device allowing the accurate treatment of a fluid with a chemical.

It is another object of the present invention to provide a device that allows the accurate flow of a fluid through the device to be treated with a chemical.

It is another object of the present invention to provide a device that allows both the gross and fine adjustment of the flow of a liquid through the device to be treated with a chemical.

It is another object of the present invention to provide a water chlorinating device that allows the accurate treatment of a flow of water with chlorine.

It is another object of the present invention to provide a water chlorinating device that provides a steadier flow of water to a chemical compartment.

It is another object of the present invention to provide a water chlorinating device that is not complex in manufacture, is simple and economical in use, and provides an appropriate level of performance.

These objects, and other object, features and advantages of the present invention, will become more apparent to those of ordinary skill in the art when the following detailed description of the preferred embodiments is read in conjunction with the appended figures, in which like reference numerals represent like components throughout the various figures.

### DESCRIPTION OF THE DRAWINGS

FIG. 1 is a perspective view of the invention.

FIG. 2 is a side elevational view of the invention installed on a water recirculation line.

FIG. 3 is a side sectional view of the invention along line 3-3′ of FIG. 4.

FIG. 4 is a front elevational view of the invention.

FIG. 5 is a front sectional view of the invention along line 5-5′ of FIG. 3.

FIG. 6 is a top elevational view of the invention with the lid removed.

FIG. 7 is a bottom sectional view of the invention along line 7-7′ of FIG. 4.

FIG. 8 is a schematic side sectional view of the invention along line 3-3′ of FIG. 4.

FIG. 9 is a schematic view of a water recirculation system including the invention.

### DETAILED DESCRIPTION OF THE PREFERRED EMBODIMENTS

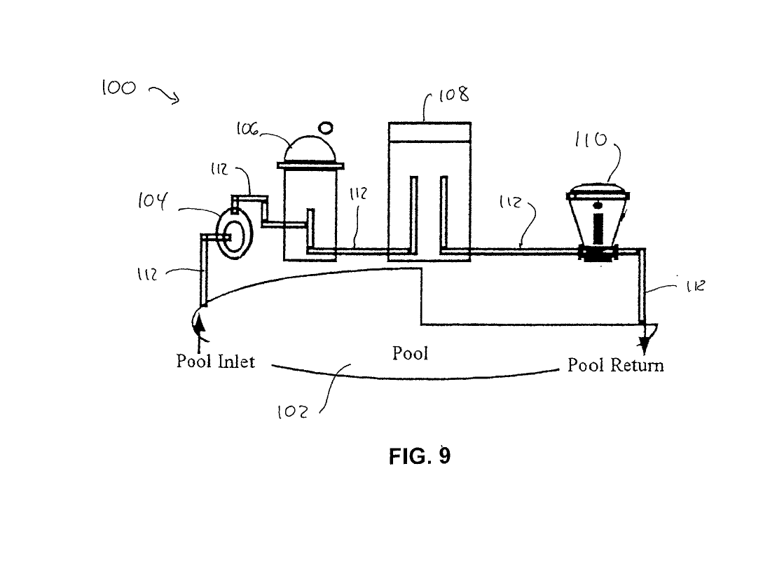

Referring now to the FIGS., the present invention is a chlorination device 10 that is part of a complete the water recirculation system 100 as shown in FIG. 9. Water recirculation systems are used to treat and recirculate water in a swimming pool, spa, hot tub, or other water bath. Typically, water recirculation systems comprise pool 102, pump 104, filter 106, settling tank 108, chlorinator 110 such as the present device 10, and associated connecting piping 112. The present chlorinator generally is a device that redirects a portion of the recirculating water from the water flow stream through one or more flow indicators and control valves, into a chemical holding compartment, and then back into the water flow stream through a check valve.

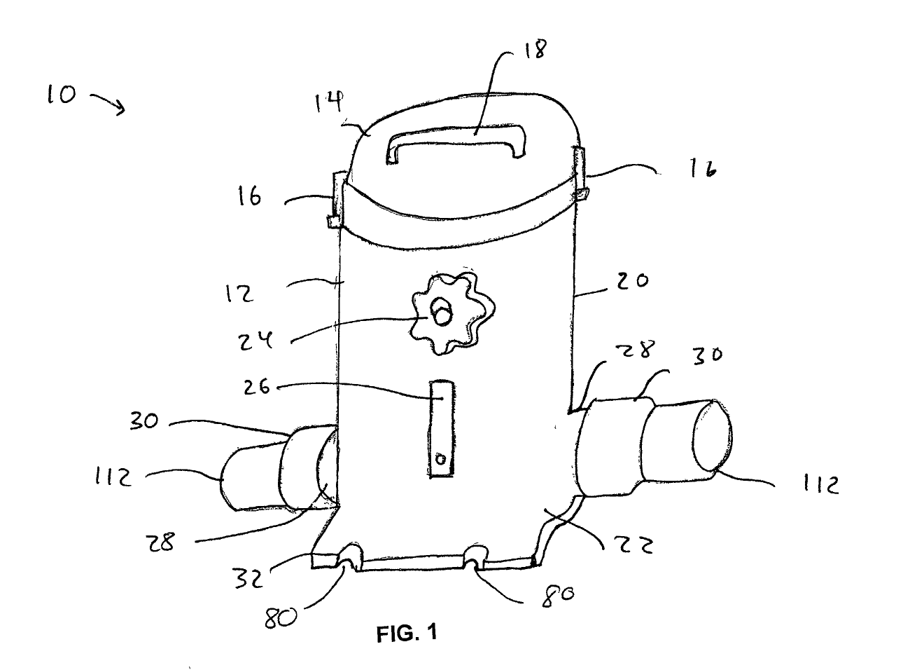

Referring now to FIGS. 1, 2 and 4, the major external components of chlorinator 10 are shown. Chlorinator 10 comprises base 12 and lid 14. Base 12 comprises upper portion 20 and lower portion 22. Upper portion 20 provides support for control valve knob 24 and flow indicator 26. Lower portion 22 provides support for pipe stem 28, attachment collar 30, mounting flange 32, and associated piping 112. Upper portion 20 and lower portion 22 preferably are a seamless unit. Lid 14 attaches to base 12 to create a generally leak-resistant seal between lid 14 and base 12, and preferably is locked in place using at least one locking mechanism 16. A leak-resistant seal is highly desirable to prevent chemically treated water from seeping out between lid 14 and base 12. Lid 14 further can comprise handle 18 to assist in carrying chlorinator 10 or removing lid 14.

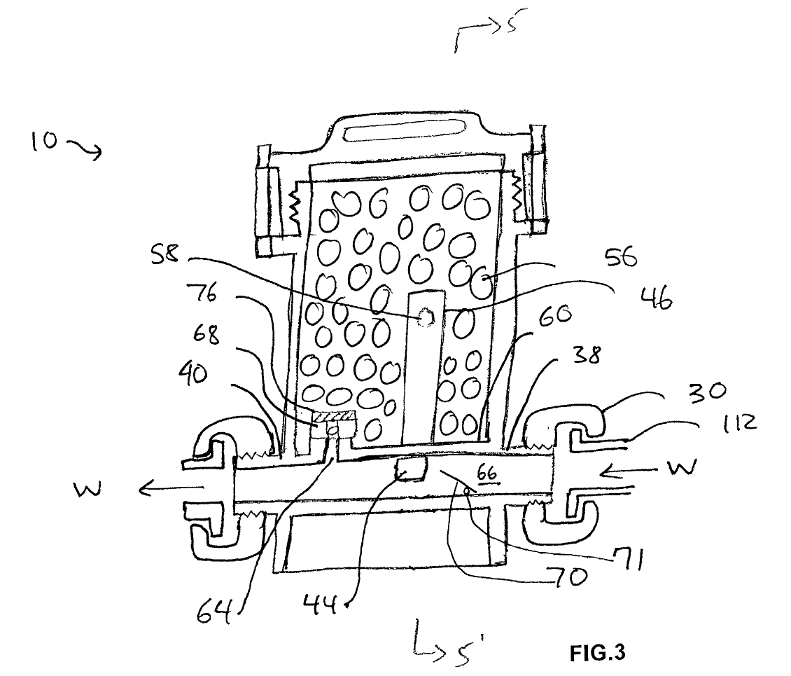

Referring now to FIGS. 3, 5, 6, 7, and 8, the internal structure of chlorinator 10 is shown. Chlorinator 10 comprises chemical compartment 34 located above and in direct fluid communication with pipe 36. Pipe 36 is attached directly to the water recirculation system 100 of the pool, spa, hot tub, or other water bath. More specifically, attachment collar 30 connects pipe 36 to associated piping 112 on both upstream end 38 and downstream end 40 of pipe 36. Facing upstream end 38 of pipe 36, on the inside diameter 42, at least one intake scoop 44 extends centrally from pipe 36 wall a certain distance toward the center of pipe 36. Scoop 44 redirects water flowing through the water recirculation system into at least one side path 46 that leads ultimately to chemical compartment 34.

Side path 46 extends generally upwards from pipe 36 to a location proximal to the top of chemical compartment 34. Control valve 48 and flow indicator 26 are located within side path 46 between pipe 36 and chemical compartment 34. Water is redirected from the water circulation system by scoop 44 into side path 46. Flow indicator 26 preferably is a common floating ball indicator situated horizontally within side path 46. Water flowing through side path 46 causes indicator ball 50 to move upwards in the direction of the water flow, and the height to which indicator ball 50 moves indicates the quantity of water flowing through side path 46. Side path 46 also may comprise bypass 52 to allow a greater quantity of water to flow through side path 46. Bypass 52 preferably allows water to flow only around flow indicator 26, and not around control valve 48. Bypass 52 diverges from the water path to flow indicator 26 upstream from flow indicator 26 but within side path 46 downstream from scoop 44. Bypass 52 then converges with the water path from flow indicator 26 downstream from flow indicator 26 but within side path 46 upstream from control valve 48 and chemical compartment 34.

Control valve 48, which is user actuated by knob 24 on the outside of chlorinator 10, allows the user to control the quantity of water flowing through side path 46. Control valve 48 preferably is located above (downstream from) flow indicator 26, and downstream of the convergence point 54 of the exit from flow indicator 26 and the exit point of bypass 52. Thus, control valve 48 controls the entire flow from side path 46, including the flow through flow indicator 26 and the flow through bypass 52, into chemical compartment 34, and can be used to increase, decrease, or stop the flow through side path 46 into chemical compartment 34. Control valve 48 preferably is a rotary stem valve.

Chemical compartment 34 is a generally funnel-shaped compartment dimensioned to hold an appropriate quantity of chemical 56, such as chlorine tablets. Chemical compartment 34 specifically is designed to hold a quantity of common pool chlorination tablets 56, but generally can hold a quantity of other types of chemical. Water passing through control valve 48 is directed through port 58 into chemical compartment 34, preferably at approximately the mid-height point of chemical compartment 34. As the water gravity falls through chemical compartment 34, the water contacts chemical 56 within chemical compartment 34, thus dissoluting chemical 56 into the water resulting in chemically treated water. At least a portion of bottom wall 60 of chemical compartment 34 is the upper wall 62 of pipe 36.

Return port 64 is located through pipe upper wall 62 between chemical compartment 34 and interior 66 of pipe 36, allowing the chemically treated water to exit chemical compartment 34 and return to the water recirculation system, Return port 64 is located downstream from scoop 44 so that the chemically treated water is not redirected from the water circulation stream into side path 46. Check valve 68 is located within return port 64 and prevents water from entering chemical compartment 34 through return port 64. The chemically treated water then mixes with the main flow of water in the recirculation system and returns to the pool, spa, hot tub, or other water bath 102.

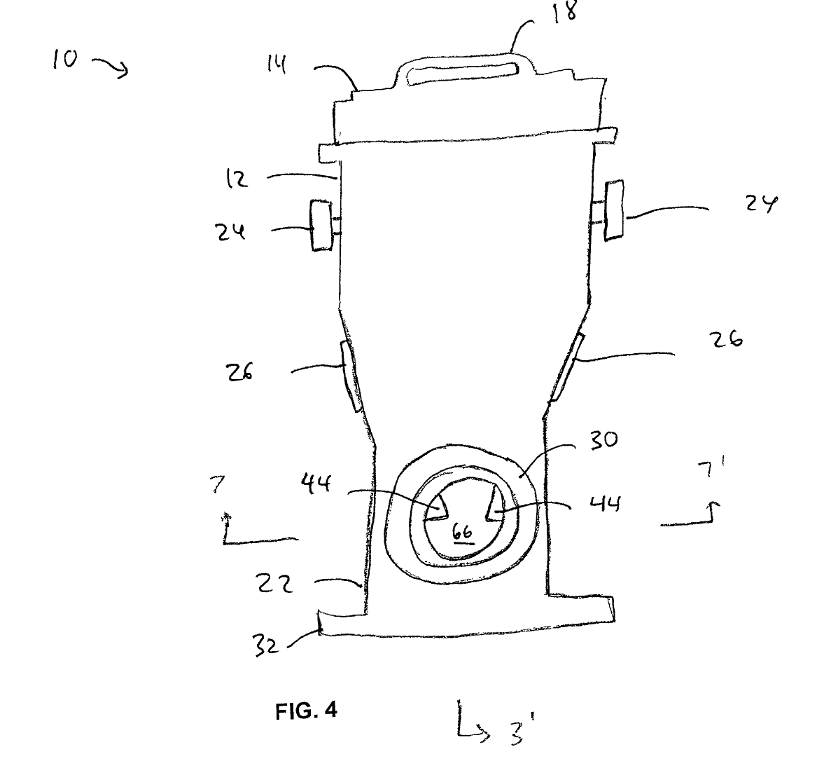

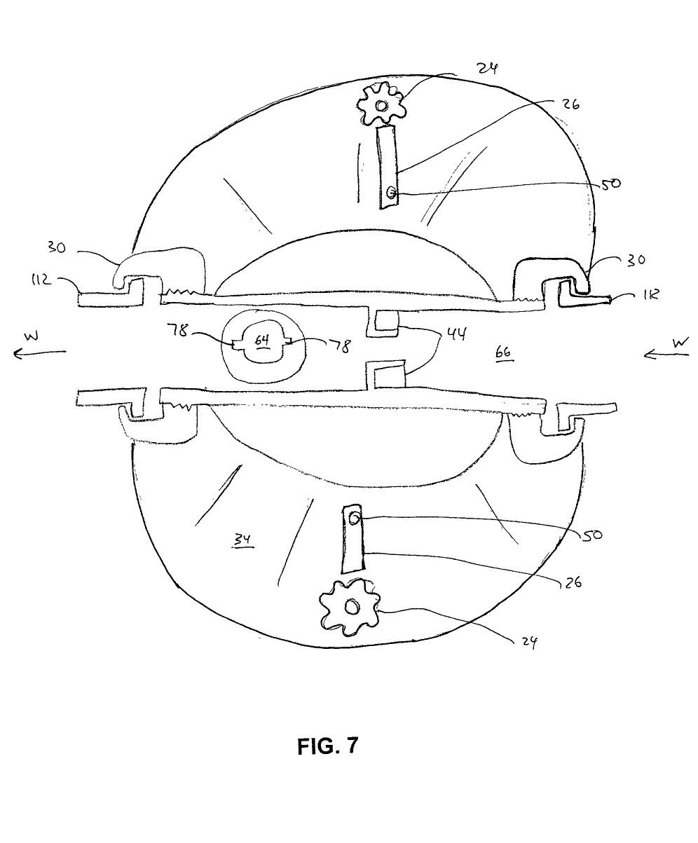

FIG. 3 shows a side cross-section of chlorinator 10 and FIG. 7 shows a bottom cross-section of chlorinator 10. Water W from water recirculation system 100 flows into chlorinator 10 through associated piping 112 and into upstream end 38 of pipe 36. Water W encounters scoop 44 and is diverted into side path 44. As can be seen in FIGS. 4, 5, 7, and 8, it is preferable to have two scoops 44 each leading to independent side paths 46. If only one scoop and side path 46 are desired, either one of scoops 44 shown in the FIGS. can be removed.

Diverter valve 70 optionally can be mounted within interior 66 of pipe 36 proximal to scoop 44 if necessary or desired. Diverter valve 70 optionally is spring-loaded using spring 71 or a like device. Diverter valve 70 performs several functions. First, diverter valve 70 diverts additional water W to scoop 44. Second, diverter valve 70 helps to prevents a backflow of treated water exiting chemical compartment 34 through check valve 68 into pipe 36, or any treated water in pipe 36 downstream from diverter valve 70, from backflowing upstream to the recirculation equipment. Third, diverter valve 70 helps to prevent a backflow of gases that may be present in pipe 36, such as chlorine-containing gases generated by this type of recirculation system, from backflowing upstream to the recirculation equipment. Chlorine-containing water and gases, especially with high chlorine content, are corrosive and can damage the recirculation equipment used in this type of recirculation system.

The spring-loading is biased in the closed position such that with no water W flowing through the recirculation system, such as when the recirculation system is off, diverter valve 70 will be in the closed or high diversion position, preventing backflow. When there is a small volume of water W flowing through the recirculation system, diverter valve 70 will be biased toward the closed or high diversion position, such that a relatively higher percentage of the water W will be diverted toward scoop 44, thus ensuring that even in situations where the volume of water W flowing through the recirculation system is small, the water W will be treated in chlorinator 10. When there is a large volume of water W flowing through the recirculation system, diverter valve 70 will be forced toward the open or low diversion position, such that water back pressure will be reduced and side path 46 will not be overburdened.

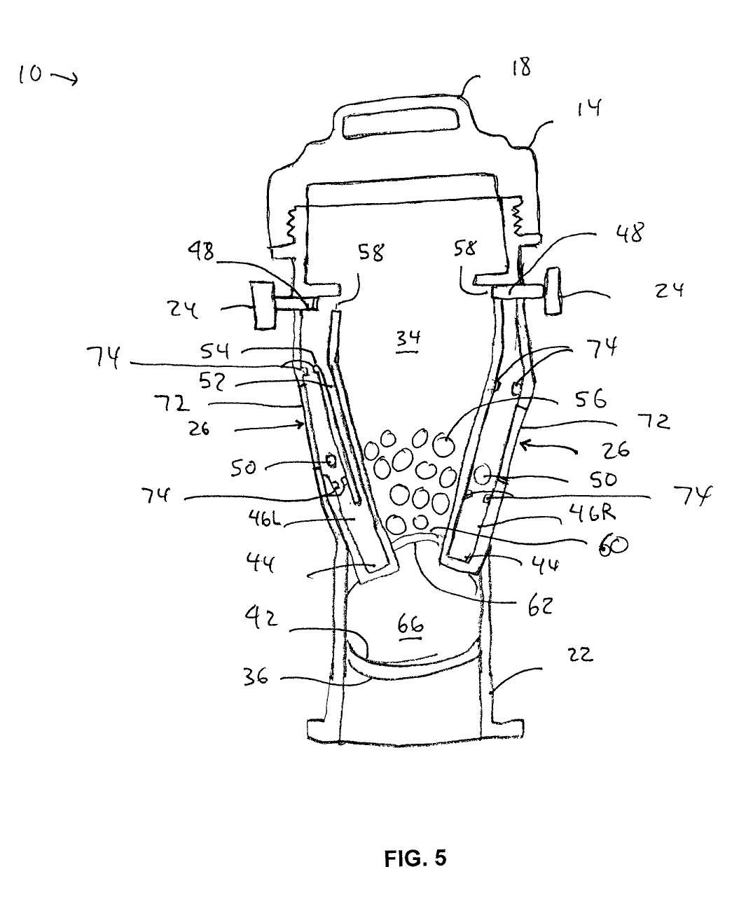

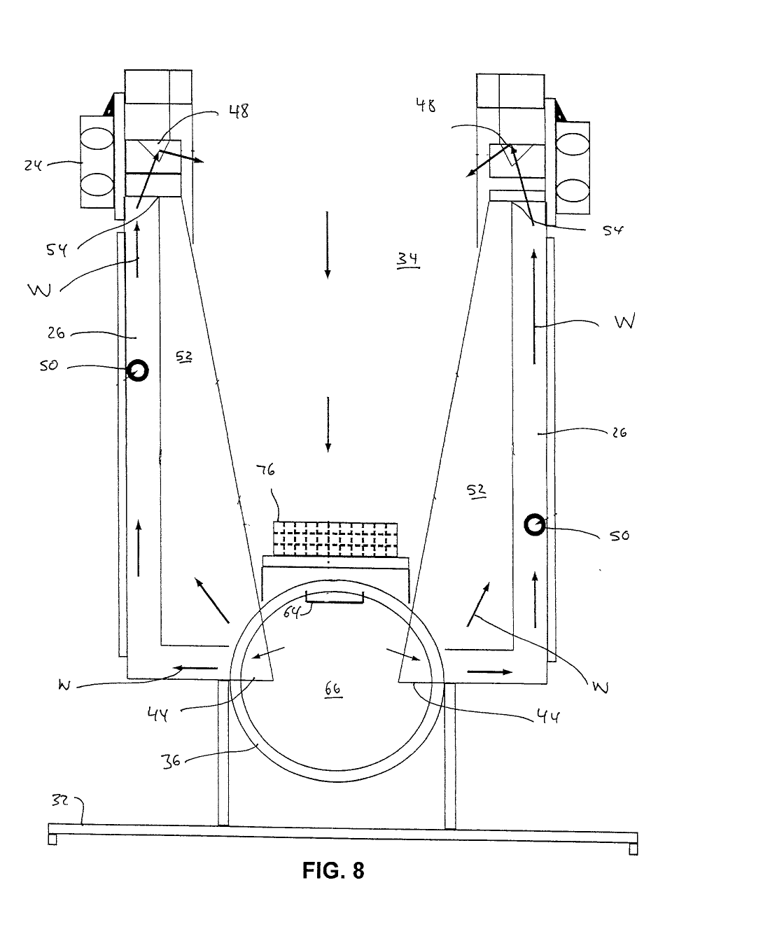

FIG. 5 shows a front cross-section of chlorinator 10 and FIG. 8 shows a schematic cross-section of chlorinator 10. Water W redirected form pipe 36 by scoop 44 enters side path 46. FIG. 5 shows two different types of side path 46. Left combination side path 46L comprises a flow indicator 26 path and a bypass 52, while right single side path 46R comprises only a flow indicator 26 path. Any combination of side paths 46L, 46R can be used, namely only one combination side path 46L, only one single side path 46R, two combination side paths 46L, two single side paths 46R, or one combination side path 46L and one single side path 46R.

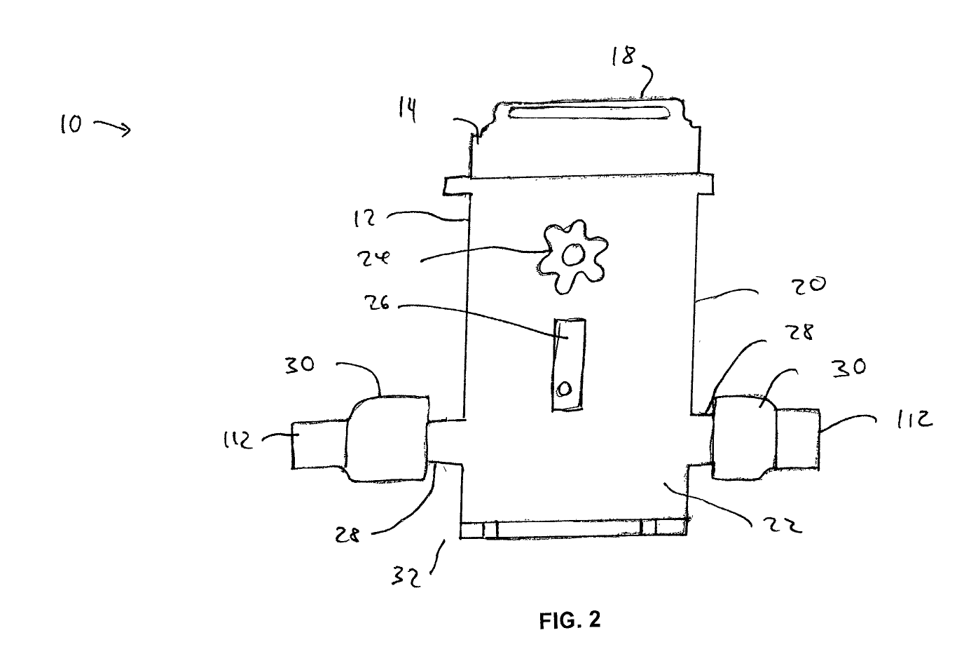

Water W entering side path 46 encounters flow indicator 26 and contacts indicator ball 50, causing it to move in the direction of water flow. The greater the flow of water W through flow indicator 26, the more indicator ball 50 will move. Sight glass 72, shown in FIGS. 1 and 2, allow the user to view the height of indicator ball 50 and to determine the setting for control valve 48. Indicator ball 50 is small enough to allow water W to pass by indicator ball and to leave flow indicator 26, yet is large enough to be prevented from leaving flow indicator 26 by barriers 74. When single side path 46R is used, all of water W flows through flow indicator 26. When combination side path 46L is used, a portion of water enters bypass 52 and bypasses flow indicator 26. Water W bypassing flow indicator 26 through bypass 52 recombines with water W flowing through flow indicator 26 at convergence point 54. It is preferable to use at least one combination side path 46L. In one embodiment, side path 46 is designed to accommodate the typical range of flow through a recirculation system, namely between 20 gallons per minute and 220 gallons per minute. By increasing the cross-sectional area of side path, and by commensurate increases in the size of flow indicator 26 and control valve 48, larger volumes of water can be accommodated.

Water W exiting flow indicator 26 and/or bypass 52 encounters control valve 48. Control valve 48 preferably is a variable flow rotary stem valve that the user can actuate to allow a determined flow of water W there through, or to stop the flow of water W altogether. Based on the amount of chlorine desired in the water W, the user can adjust control valve to allow more or less water into chemical chamber to contact chemical 56. Water W flowing through control valve 48 exits side path 46 through port 58 and into chemical compartment 34. If two side paths 46 are used, two control valves 48 are used, one in conjunction with each side path 46. Each control valve 48 can be controlled independently, allowing a determined quantity of water W to flow through each side path 46. However, it has been found that for ease of use, one control valve 46 can be left all the way open, allowing maximum water W flow through the respective side path 46, and the other control valve 48 can be used to fine tune the amount of water entering chemical compartment 34.

FIG. 3 shows a side cross-section of chemical compartment 34 and FIG. 5 shows a front cross-section of chemical compartment 34. Water W flowing through side path 46 flows through control valve 48 and port 58 into chemical compartment 34. In chemical compartment 34, water W contacts chemical 56, dissoluting chemical 56 into water W resulting in chemically treated water. FIG. 3 shows chemical 56 filling the majority of chemical compartment 34, which is the general filled position. FIG. 5 shows chemical 56 filling only a portion of chemical compartment 34, which is the general position after an amount of chemical 56 has been dissoluted into water W. Alternatively, the user can put as much or as little chemical 56 into chemical compartment 34 as desired or needed.

FIG. 5 shows in greater detail the preferred placement of port 58 relative to the height of chemical compartment 34. This allows the user to place additional chemical 56, that is more chemical 56 than is needed, in chemical compartment 34. By doing so, there generally is a quantity of chemical 56 in chemical compartment 34 sufficient to last an extended period of time during treatment. FIG. 5 also shows control valve 48 in two different positions. Control valve 48 associated with combination side path 46L is in a partially open position. Control valve 48 associated with single side path 46R is in a closed position. This illustrates how control valves 48 can be independently positioned.

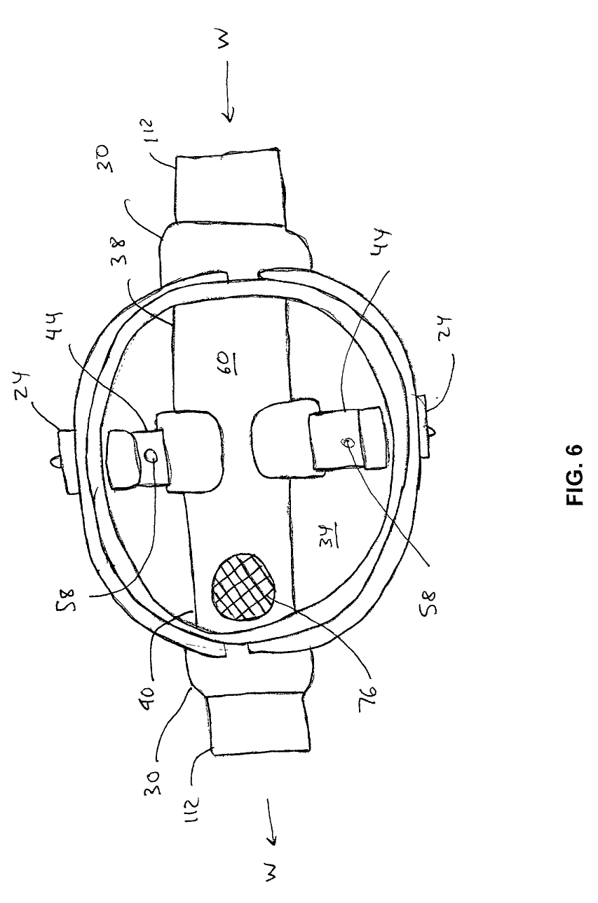

FIG. 3 shows a side cross-section of return port 64 and check valve 68, FIG. 6 shows a top view of check valve 68, and FIG. 7 shows a bottom view of return port 64. Water W exits chemical compartment 34 through return port 64, which is located through the upper wall 62 of pipe 36, which also is part of the bottom wall of chemical compartment 34. Return port 64 is located downstream from scoops 44. Check valve 68 prevents water in pipe 36 from entering chemical compartment 34 through return port 64 and comprises a vertical tube and internal ball. Back pressure from water in pipe 36 forces the ball upwards in check valve 68, thus closing check valve 68. Thus, when the water pressure in chemical compartment 34 is greater than the water pressure in pipe 36, which is the case when water is flowing into chemical compartment 34, chemically treated water can exit chemical compartment 34 into pipe 36. When no water is flowing into chemical compartment 34, the water pressure in pipe 36 is greater than the water pressure in chemical compartment 34, and check valve 68 will close. Screen 76 is located on the op of check valve 68 to prevent undissolved particles of chemical 56 from passing through check valve 68 into the recirculating water stream. Check valve 68 is anchored into return port 64 using a twist and lock mechanism fitting through slots 78.

FIG. 8 is a schematic side cross-section of chlorinator 10 showing in schematic detail the various internal components of chlorinator 10.

FIGS. 1 and 2 show mounting flange 32 comprising mounting slots 80. Chlorinator 10 can be mounted onto any flat surface by using screws, bolts or other mounting means. Chlorinator 10 is placed on the flat surface, and screws, bolts or other mounting means are placed within mounting slots 80 and secured to the flat surface. When mounting chlorinator, access to lid 14 must be available so that lid 14 can be removed and chemical 56 introduced to chemical compartment 34. Chlorinator 10 can be mounted with or without complete access to both control valves 48. If it is difficult to access one control valve 48, that control valve 48 can be left in the full open position, and the flow of water into chemical compartment 34 can be regulated with control valve 48 that has greater access.

While the invention has been described in connection with certain preferred embodiments, it is not intended to limit the spirit or scope of the invention to the particular forms set forth, but is intended to cover such alternatives, modifications, and equivalents as may be included within the true spirit and scope of the invention as defined by the appended claims. All patents, applications and publications referred to herein are hereby incorporated by reference in their entirety.

What is claimed is:

1. A device for dispensing chemicals into a fluid circulation system, comprising:
a. a fluid pipe having a fluid flow therein;
b. at least one fluid diverter extending within the fluid pipe and into the fluid flow so as to divert at least a portion of the fluid flow as a diverted fluid flow into the fluid diverter;
c. at least one side path in fluid communication with the at least one fluid diverter for receiving the diverted fluid flow;
d. a chemical compartment for containing a chemical to be introduced to the diverted fluid flow creating a chemically treated fluid flow, and a return port for returning the chemically treated fluid flow to the fluid pipe downstream from the at least one fluid diverter; and
e. at least one control valve in fluid communication with the at least one side path for controlling the flow of the diverted fluid flow into the chemical compartment.

2. The device as claimed in claim 1, wherein the chemical compartment comprises a side wall, a bottom wall, an interior, and an open top.

3. The device as claimed in claim 2, wherein the side wall comprises a port allowing fluid communication between the control valve and the interior of the chemical compartment.

4. The device as claimed in claim 3, wherein the side wall of the chemical compartment has a height, and the port is located approximately midway up the height of the side wall of the chemical compartment.

5. The device as claimed in claim 2, wherein the return port is located on the bottom wall of the chemical compartment.

6. The device as claimed in claim 1, wherein the at least one side path further comprises a flow indicator for indicating the relative flow of the diverted fluid flow.

7. The device as claimed in claim 6, wherein the at least one side path further comprises a bypass for allowing at least a portion of the diverted fluid flow to bypass the flow indicator.

8. The device as claimed in claim 7, wherein the flow indicator and the bypass converge upstream from the control valve.

9. The device as claimed in claim 1, wherein the return port comprises a check valve for preventing fluid flow from the pipe into the chemical compartment.

10. The device as claimed in claim 9, wherein the return port further comprises a screen for preventing particles of the chemical from flowing through the return port into the pipe.

11. The device as claimed in claim 1, wherein the fluid is water and the chemical is a chlorine containing compound.

12. The device as claimed in claim 1, comprising two side paths.

13. The device as claimed in claim 12, comprising two flow indicators.

14. The device as claimed in claim 13, comprising two bypasses.

15. The device as claimed in claim 1, further comprising a diverter/backflow valve located within said pipe proximal to said at least one fluid diverter.

16. The device as claimed in claim 15, wherein said diverter/backflow valve has a means for biasing said diverter/backflow valve to a closed position.

17. The device as claimed in claim 15, wherein said diverter/backflow valve directs fluid flowing through said pipe in the general direction of said at least one fluid diverter.

18. The device as claimed in claim 15, wherein said diverter/backflow valve when in a closed position prevents backflow upstream in said pipe.

19. The device as claimed in claim 16, wherein said means for biasing is a spring.

20. A device for dispensing chlorine into a pool water recirculation system, comprising:
a. a fluid pipe having a water flow therein;
b. at least one fluid diverter extending within the fluid pipe and into the water flow so as to divert at least a portion of the water flow as a diverted water flow into the fluid diverter;
c. at least one side path in fluid communication with the at least one fluid diverter for receiving the diverted water flow;
d. a chemical compartment for containing a chlorine-containing chemical to be introduced to the diverted water flow creating a chlorine treated water flow, and a return port for returning the chlorine treated water flow to the fluid pipe downstream from the at least one fluid diverter; and
e. at least one control valve in fluid communication with the at least one side path for controlling the flow of the diverted water flow into the chemical compartment.

21. The device as claimed in claim 20, wherein the chemical compartment comprises a side wall comprising a port allowing fluid communication between the control valve and the interior of the chemical compartment, a bottom wall comprising the return port, an interior for containing the chlorine-containing chemical, and an open top through which the chlorine-containing chemical is introduced to the interior of the chemical compartment.

22. The device as claimed in claim 21, wherein the at least one side path further comprises a bypass for allowing at least a portion of the diverted water flow to bypass the flow indicator.

23. The device as claimed in claim 22, comprising two side paths.

24. The device as claimed in claim 23, comprising two flow indicators.

25. The device as claimed in claim 24, comprising two bypasses.

26. The device as claimed in claim 20, further comprising a diverter/backflow valve located within said pipe proximal to said at least one fluid diverter.

27. The device as claimed in claim 26, wherein said diverter/backflow valve has a means for biasing said diverter/backflow valve to a closed position.

28. The device as claimed in claim 26, wherein said diverter/backflow valve directs fluid flowing through said pipe in the general direction of said at least one fluid diverter.

29. The device as claimed in claim 26, wherein said diverter/backflow valve when in a closed position prevents backflow upstream in said pipe.

30. The device as claimed in claim 27, wherein said means for biasing is a spring.
